(19) United States
(12) Patent Application Publication
(10) Pub. No.: US 2024/0114408 A1
(43) Pub. Date: Apr. 4, 2024

(54) CELL HANDOVER METHOD AND APPARATUS, DEVICE, AND STORAGE MEDIUM

(71) Applicant: GUANGDONG OPPO MOBILE TELECOMMUNICATIONS CORP., LTD., Dongguan (CN)

(72) Inventors: Xin You, Dongguan (CN); Cong Shi, Dongguan (CN)

(21) Appl. No.: 18/541,820

(22) Filed: Dec. 15, 2023

Related U.S. Application Data
(63) Continuation of application No. PCT/CN2021/100166, filed on Jun. 15, 2021.

(51) Int. Cl. H04W 36/00; H04W 36/08

(52) U.S. Cl. CPC H04W 36/00833; H04W 36/08

(57) ABSTRACT

The present disclosure relates to the field of communication technology, and provides a cell handover method and apparatus, a device, and a storage medium. The method includes: determining at least one handover information in a cell handover process based on a first AI model. Since the UE determines at least one handover information in the cell handover process based on autonomous decision-making of the AI model, it can select an appropriate handover timing or target cell autonomously to complete cell handover, thereby improving the efficiency of the cell handover, reducing the time required for the cell handover, and ensuring the handover success rate.

### CROSS-REFERENCE TO RELATED APPLICATIONS

The application is a continuation of International Application No. PCT/CN2021/100166 filed on Jun. 15, 2021, the entire content of which is incorporated herein by reference.

### TECHNICAL FIELD

The present disclosure relates to the field of communication technology, and more particularly, to a cell handover method and apparatus, a device, and a storage medium.

### BACKGROUND

Cell handover is an important process in mobility management of a User Equipment (UE). Cell handover is mainly decided by a base station.

In the related art, a UE transmits a measurement report to a base station, and the measurement report indicates channel quality of a serving cell and neighboring cells. After receiving the measurement report, the base station can select a neighboring cell with higher channel quality as a target cell to trigger a handover process of the UE from the serving cell to the target cell. For example, the base station transmits a handover command to the UE. After receiving the handover command, the UE initiates a random access procedure to the target cell, and then completes the cell handover.

Since it takes a period of time after the UE reports the measurement report and before the UE receives the handover command, the communication environment may have degraded too much in this period of time. When the base station transmits the handover command to the UE, the UE may be unable to receive the handover command due to the degraded communication environment, resulting in a handover failure.

### SUMMARY

The present disclosure provides a cell handover method and apparatus, a device, and a storage medium, capable of allowing a UE to determine at least one handover information in a cell handover process based on autonomous decision-making of an AI model, and then complete the cell handover autonomously, thereby improving the efficiency of the cell handover.

According to an aspect of an embodiment of the present disclosure, a cell handover method is provided. The method includes: determining at least one handover information in a cell handover process based on a first AI model.

According to an aspect of an embodiment of the present disclosure, a cell handover method is provided. The method includes: training or learning input information based on a first AI model to obtain first information; and transmitting the first information to a terminal, the terminal being configured to determine at least one handover information in a cell handover process based on the first information.

According to an aspect of an embodiment of the present disclosure, a cell handover apparatus is provided. The apparatus includes: a determining module configured to determine at least one handover information in a cell handover process based on a first AI model.

According to an aspect of an embodiment of the present disclosure, a cell handover apparatus is provided. The apparatus includes: an AI module configured to train or learn input information based on a first AI model to obtain first information; and a transmitting module configured to transmit the first information to a terminal, the terminal being configured to determine at least one handover information in a cell handover process based on the first information.

According to an aspect of an embodiment of the present disclosure, a terminal is provided. The terminal includes: one or more processors; and one or more transceivers connected to the one or more processors. The one or more processors are configured to determine at least one handover information in a cell handover process based on a first AI model

According to an aspect of an embodiment of the present disclosure, a network device is provided. The network device includes: one or more processors; and one or more transceivers connected to the one or more processors. The one or more processors are configured to perform the above cell handover method.

According to an aspect of an embodiment of the present disclosure, a computer-readable storage medium is provided. The computer-readable storage medium has a computer program stored therein. The computer program, when executed by a processor, performs the above cell handover method.

According to an aspect of an embodiment of the present disclosure, a computer program product or computer program is provided. The computer program product or computer program includes computer instructions. The computer instructions are stored in a computer-readable storage medium, and a processor reads from the computer-readable storage medium and executes the computer instructions, so as to perform the above cell handover method.

The technical solutions according to the present disclosure have at least the following advantageous effects.

The UE determines at least one handover information in the cell handover process based on autonomous decision-making of the AI model, and then selects an appropriate handover timing autonomously to complete cell handover, thereby improving the efficiency of the cell handover, reducing the time required for the cell handover, and ensuring the handover success rate.

### BRIEF DESCRIPTION OF DRAWINGS

In order to describe the technical solutions in the embodiments of the present disclosure more clearly, the drawings to be used in the description of the embodiments will be briefly introduced below. Obviously, the drawings in the following description are only some embodiments of the present disclosure, and other drawings can be obtained by those of ordinary skill in the art based on these drawings without any inventive efforts.

FIG. 1 is a structural diagram of a communication network architecture according to an embodiment of the present disclosure;

FIG. 2 is a flowchart illustrating a cell handover method according to an embodiment of the present disclosure;

FIG. 3 is a flowchart illustrating a cell handover method according to an embodiment of the present disclosure;

FIG. 4 is a schematic diagram showing a structure of a first AI model according to an embodiment of the present disclosure;

FIG. 5 is a schematic diagram showing a structure of a first AI model according to an embodiment of the present disclosure;

FIG. 6 is a flowchart illustrating a cell handover method according to an embodiment of the present disclosure;

FIG. 7 is a schematic diagram showing a structure of a cell handover apparatus according to an embodiment of the present disclosure;

FIG. 8 is a schematic diagram showing a structure of a cell handover apparatus according to an embodiment of the present disclosure; and

FIG. 9 is a schematic diagram showing a structure of a terminal or network device according to an embodiment of the present disclosure.

### DESCRIPTION OF EMBODIMENTS

The embodiments of the present disclosure will be further described in detail below with reference to the accompanying drawings, such that the objects, technical solutions, and advantages of the present disclosure will become more apparent.

The system architecture and service scenarios described in the embodiments of the present disclosure are intended to illustrate the technical solutions of the embodiments of the present disclosure more clearly, and do not constitute any limitation on the technical solutions according to the embodiments of the present disclosure. It can be appreciated by those of ordinary skill in the art that with the evolution of the network architecture and the emergence of new service scenarios, the technical solutions according to the embodiments of the present disclosure will be equally applicable to similar technical problems.

FIG. 1 is a block diagram of a communication network architecture in an exemplary embodiment of the present disclosure, and the communication network architecture may include: a network device 11 and a terminal 12.

Here, the network device may be a base station, which is a device deployed in an access network to provide a wireless communication function for terminals. The base station may include various forms of macro base stations, micro base stations, relay stations, access points, and the like. In systems using different wireless access technologies, the names of devices with base station functions may be different. For example, in the Long Term Evolution (LTE) system, they are referred to as eNodeB or eNB, and in the 5G NR-U system, they are referred to as gNodeB or gNB. As communications technology evolves, the description “base station” may change.

The terminal 12 may refer to a user equipment (UE), an access terminal, a subscriber unit, a subscriber station, a mobile station, a mobile, a remote station, a remote terminal, a mobile device, a wireless communication device, a user agent, or a user device. In some embodiments, the terminal 12 can also be a cellular phone, a cordless phone, a Session Initiation Protocol (SIP) phone, a Wireless Local Loop (WLL) station, a Personal Digital Assistant (PDA), a handheld device with wireless communication functions, a computing device or another processing device connected to a wireless modem, a vehicle-mounted device, a wearable device, a terminal device in a 5th Generation System (5GS), or a terminal device in a future evolved Public Land Mobile Network (PLMN), etc., and the present disclosure is not limited to this.

The technical solutions of the embodiments of the present disclosure can be applied to various communication systems, such as: Global System of Mobile Communication (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Advanced Long Term Evolution (LTE-A) system, New Radio (NR) system, evolved system of the NR system, LTE-based access to Unlicensed spectrum (LTE-U) system, NR-U system, Universal Mobile Telecommunication System (UMTS), Worldwide Interoperability for Microwave Access (WiMAX) communication system, Wireless Local Area Network (WLAN), Wireless Fidelity (WiFi), next-generation communication system or other communication systems, etc.

Generally speaking, the number of connections supported by traditional communication systems is limited and easy to implement. However, with the development of communication technology, mobile communication systems will not only support traditional communication, but also support, for example, Device to Device (D2D) communication, Machine to Machine (M2M) communication, Machine Type Communication (MTC), Vehicle to Vehicle (V2V) communication and Vehicle to Everything (V2X) system, etc. The embodiments of the present disclosure may also be applied to these communication systems.

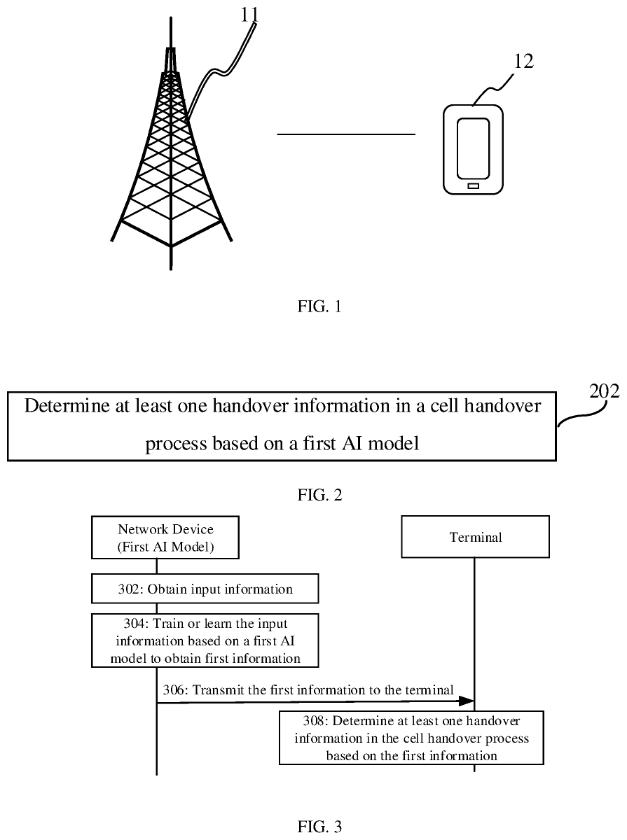

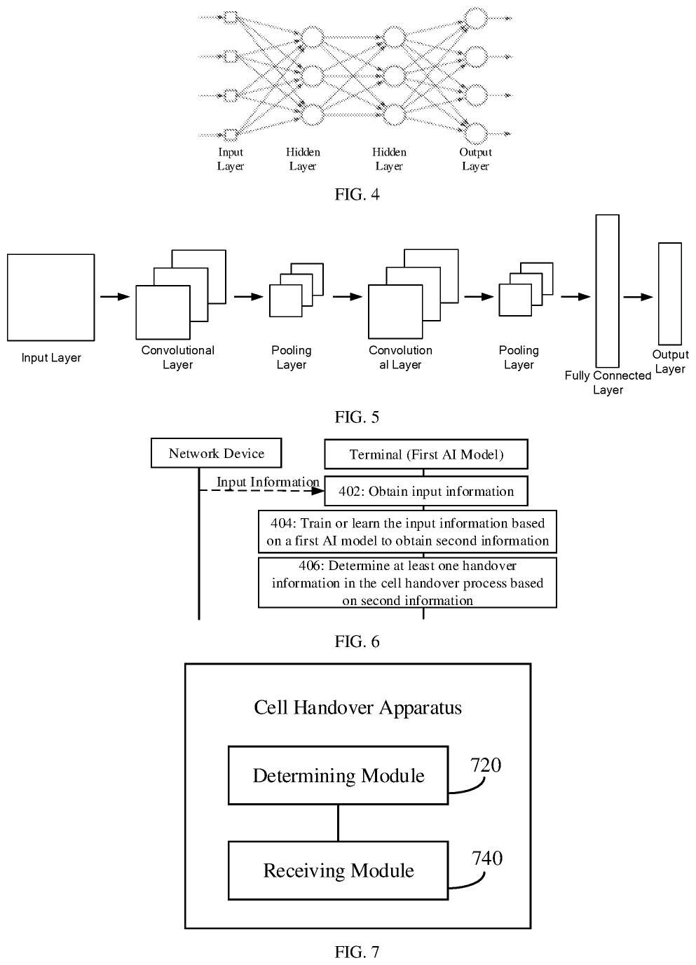

FIG. 2 is a flowchart illustrating a cell handover method according to an exemplary embodiment of the present disclosure. The method can be performed by a terminal or a network device, and the method performed by the terminal will be taken as an example. The method includes:

at Operation 202: determining at least one handover information in a cell handover process based on a first AI model.

The first AI model is an AI model used for training, learning or predicting handover information or handover auxiliary information or handover decision information in the cell handover process. The first AI model may be deployed at the terminal, or the first AI model may be deployed at an access network device.

In some embodiments, the first AI model may be at least one of a neural network model, a deep network model, a multi-hidden layer network model, or a convolutional neural network model. The embodiment of the present disclosure is not limited to any specific type of the first AI model.

In the traditional cell handover process, the handover information is obtained based on analysis and judgment of a measurement report by a base station, and there may be a certain lag. In the embodiment of the present disclosure, at least one handover information is determined based on the first AI model. The handover information may include at least one of:
target cell;

(A target cell is one of one or more neighboring cells. Based on the first AI model, the terminal or network device determines the target cell in the cell handover process.)
target beam;

(A target beam is one of one or more candidate beams. Based on the first AI model, the terminal or the network device determines the target beam in the cell handover process. For example, the target beam corresponds to a reference signal. The reference signal may be a Channel State Information-Reference Signal (CSI-RS); a Synchronization Signal Block (SSB); or a Sounding Reference Signal (SRS)).
handover timing;

(A handover timing refers to a timing of handover from a serving cell to a target cell, which can be specific time information, location information, or channel quality information.)
handover condition;

(A handover condition refers to a condition for handover from a serving cell to a target cell. When the handover condition is satisfied, the terminal is handed over from the serving cell to the target cell.)
measurement time; or

(Measurement time is time for the terminal to measure cell signals from a serving cell and neighboring cells.)
handover type.

(A handover type includes, but not limited to: traditional handover, conditional handover, Dual Active Protocol Stack (DAPS) handover and RACH-LESS handover, in which:
Basic handover: The terminal reports a measurement report based on a measurement result, and the network device triggers the handover process after receiving the measurement report. After the network device determines the target cell, the network device transmits a handover command to the terminal. After receiving the handover command, the terminal initiates random access to the target cell and completes the handover process.
Conditional handover: A first trigger condition and a second trigger condition are introduced. The first trigger condition triggers the terminal to perform measurement reporting and triggers the network device to prepare for handover. The second trigger condition triggers the terminal to initiate random access to the target cell to complete the cell handover process. Here, the first trigger condition is weaker than the second trigger condition, and the terminal first meets the first trigger condition and triggers reporting of a measurement report to the network device, thereby triggering a cell handover preparation process. Then, when the terminal meets the second handover condition, the terminal can initiate random access to the target network device, thereby completing the cell handover process.
DAPS handover: After receiving a Radio Resource Control (RRC) message for cell handover, the connection with the source base station is maintained until the source cell is released after successful random access to the target base station.
RACH-LESS handover: The terminal knows the time advance of the target cell and communicates directly with the target cell without performing a random access procedure.)

To summarize, in the cell handover method according to the embodiment of the present disclosure, the UE determines at least one handover information in the cell handover process based on autonomous decision-making of the AI model, and then selects an appropriate handover timing or a target cell autonomously to complete cell handover, thereby improving the efficiency of the cell handover, reducing the time required for the cell handover, and ensuring the handover success rate.

For the situation where the first AI model is deployed at a network device:

FIG. 3 is a flowchart illustrating a cell handover method according to an exemplary embodiment of the present disclosure. This method can be performed by a terminal and a network device. The method includes the following operations.

At Operation 302, a network device obtains input information.

The input information is information for being input to a first AI model. The first AI model is an AI model used for training, learning or predicting handover information in a cell handover process.

In some embodiments, the input information may include at least one of:
location information of the terminal;

(The location information of the terminal can be determined by a positioning component in the terminal, such as based on Global Navigation Satellite System (GNSS) positioning, or can be obtained by positioning based on reference signals transmitted by a plurality of network devices, or using Radio Technology-dependent (RAT-dependent) positioning technology.

The location information of the terminal may include: historical location information, current location information, or a location sequence composed of a plurality of pieces of historical location information and current location information in a chronological order.

Exemplarily, the location information may include: time and location, or a location sequence composed of a plurality of sets of “time and position”.

For example, it may be a location sequence composed of location points positioned every 10 seconds within the last hour or the last day.)
uplink service information and downlink service information of the terminal;

(The uplink service information and downlink service information of the terminal may include: at least one of uplink service information of the terminal or downlink service information of the terminal. For example, the uplink service information may be a voice chat service, and the downlink service information may be a video service. Exemplarily, it may be service information experienced by the terminal at specific time.)
measurement report of the terminal;

(It may be a measurement report of signal quality of the serving cell and neighboring cells as measured by the terminal.)
handover failure information of the terminal in a historical period;

(It may be handover failure information of the terminal in a latest historical period, including e.g., time, cause, and location of a handover failure.)
deployment information of a mobile network;

(The deployment information of the mobile network is used to reflect deployment information of cell deployment and/or beam direction.)
cell load information; or

(The cell load information indicates the number of terminals that have accessed the cell, the number of terminals that can be admitted currently, or a service condition that the cell has provided to the outside world. In some embodiments, the cell load information may also include guaranteed Quality of Service (QoS) that the cell can provide.

For example, the cell load information may include an upper limit of the number of terminals that the cell can currently admit and the number of terminals that the cell has admitted.)
auxiliary information provided by a third-party application in the terminal.

(For example, it may be train ticket information, airplane ticket information, navigation information, bus card swipe information, and subway card swipe information provided by third-party applications.)

In some embodiments, the network device may obtain the input information in at least one of the following schemes, as non-limiting examples:
1. Receiving the input information transmitted by a neighboring cell network device via an Xn interface;

(The Xn interface is a communication interface or reference point between neighboring base stations. A first network device corresponding to a serving cell and a second network device corresponding to a neighboring cell are connected through the Xn interface. The first network device may be referred to as a network device for short, and the second network device may be referred to as a neighboring cell network device for short. In the case where the input information comes from the neighboring cell network device, the network device receives the input information transmitted by the neighboring cell network device through the Xn interface.)
2. Receiving the input information transmitted by a neighboring cell network device via a first AI interface;

(Illustratively, the first AI interface may be a newly defined communication interface between the network device and the neighboring cell network device. In the case where the input information comes from the neighboring cell network device, the network device receives the input information transmitted by the neighboring cell network device via the first AI interface.)
3. Receiving the input information transmitted by the terminal via RRC signaling; or

(The RRC signaling is a signaling method for communication between a terminal and a network device. In the case where the input information comes from the terminal, the network device receives the input information transmitted by the terminal via RRC signaling.)
4. Receiving the input information transmitted by the terminal via a second AI interface.

(Illustratively, the second AI interface may be a newly defined communication interface between the terminal and the network device. In the case where the input information comes from the terminal, the network device receives the input information transmitted by the terminal via the second AI interface.)

Since the input information can be of various types, and the input information may include both input information from a neighboring cell network device and input information from the terminal, in this case a combination of the above four schemes can be used to obtain various input information.

At Operation 304, the network device trains or learns the input information based on a first AI model to obtain first information.

The first AI model may be an AI model for training, learning or predicting the first information. The first information may be handover information, handover decision information, or auxiliary information for handover decision as used in a cell handover process.

Exemplarily, the first AI model is a neural network model, including: 1 input layer, 1 hidden layer, and 1 output layer. Alternatively, the first AI model may be a multi-hidden layer neural network model, including: 1 input layer, multiple cascaded hidden layers, and 1 output layer, as shown in FIG. 4. Alternatively, the first AI model may be a convolutional neural network, including: 1 input layer, multiple cascaded convolutional units, 1 fully connected layer, and 1 output layer, each convolutional unit including a convolutional layer and a pooling layer, as shown in FIG. 6. This embodiment is not limited to any specific structure of the first AI model.

Exemplarily, the first information may be information outputted from the first AI model after training or learning the input information. The first information may include at least one of:
handover command;

(The handover command is a command for instructing the terminal to handover from a serving cell to a target cell.)
measurement configuration;

(The measurement configuration includes: a measurement object configuration, a measurement quantity configuration, and a measurement report configuration, including e.g., neighbor cells, frequency points, time, frequency, etc. that need to be measured.)
configuration of a target cell; or

(The configuration of the target cell includes: an identifier of the target cell, a new Cell-Radio Network Temporary Identifier (C-RNTI), a Random Access Channel (RACH) resource, an association between RACH resources and SS/PBCH Blocks (SSBs), an association between RACH resources and UE-specific Channel-Slate Information Reference Symbol (CSI-RS) configurations, a common RACH resource, system information of the target cell, etc.)
handover condition of the target cell.

(The handover condition includes at least one of: time, location, or channel quality.)

At Operation 306, the network device transmits the first information to the terminal;

In some embodiments, the network device may transmit the first information to the terminal via RRC signaling.

At Operation 308, the terminal determines at least one handover information in the cell handover process based on the first information.

When the first information includes a handover command, the terminal performs cell handover according to the handover command.

When the first information includes a measurement configuration, the terminal performs cell measurement and reports a measurement report according to the measurement configuration. The network device transmits a handover command to the terminal based on the measurement report, and the terminal performs cell handover according to the handover command.

When the first information includes a configuration of the target cell, the terminal determines at least one parameter in the random access procedure according to the configuration of the target cell.

When the first information includes a handover condition of the target cell, the terminal performs the cell handover process when the handover condition of the target cell is satisfied.

To summarize, in the method according to this embodiment, the network device allows the AI-model-based UE to determine at least one handover information in the cell handover process based on autonomous decision-making of the AI model, and then selects an appropriate handover timing autonomously to complete cell handover, thereby improving the efficiency of the cell handover, reducing the time required for the cell handover, and ensuring the handover success rate.

For the case where the first AI model is deployed at the terminal:

FIG. 4 is a flowchart illustrating a cell handover method according to an exemplary embodiment of the present disclosure. This method can be performed by a terminal and a network device. The method includes the following operations.

At Operation 402, a terminal obtains input information.

The input information is information for being input to a first AI model. The first AI model is an AI model used for training, learning or predicting handover information in a cell handover process.

In some embodiments, the input information includes at least one of the following:
location information of the terminal;

(The location information of the terminal can be determined by a positioning component in the terminal, such as based on GNSS positioning, or can be obtained by positioning based on reference signals transmitted by a plurality of network devices, or using RAT-dependent positioning technology.

The location information of the terminal may include: historical location information, current location information, or a location sequence composed of a plurality of pieces of historical location information and current location information in a chronological order.

Exemplarily, the location information may include: time and location, or a location sequence composed of a plurality of sets of “time and position”.

For example, it may be a location sequence composed of location points positioned every 10 seconds within the last hour or the last day.)
uplink service information and downlink service information of the terminal;

(The uplink service information and downlink service information of the terminal may include: at least one of uplink service information of the terminal or downlink service information of the terminal. For example, the uplink service information may be a voice chat service, and the downlink service information may be a video service. Exemplarily, it may be service information experienced by the terminal at specific time.)
measurement report of the terminal;

(It may be a measurement report of signal quality of the serving cell and neighboring cells as measured by the terminal.)
handover failure information of the terminal in a historical period;

(It may be handover failure information of the terminal in a latest historical period, including e.g., time, cause, and location of a handover failure.)
deployment information of a mobile network;

(The deployment information of the mobile network is used to reflect deployment information of cell deployment and/or beam direction.)
cell load information; or

(The cell load information indicates the number of terminals that have accessed the cell, the number of terminals that can be admitted currently, or a service condition that the cell has provided to the outside world. In some embodiments, the cell load information may also include guaranteed Quality of Service (QoS) that the cell can provide.

For example, the cell load information may include an upper limit of the number of terminals that the cell can currently admit and the number of terminals that the cell has admitted.)
auxiliary information provided by a third-party application in the terminal.

(For example, it may be train ticket information, airplane ticket information, navigation information, bus card swipe information, and subway card swipe information provided by third-party applications.)

In some embodiments, the terminal may obtain the input information in at least one of the following schemes, as non-limiting examples:
being transmitted from a first entity in the terminal to a second entity via inter-layer interaction, the second entity being an entity in which the first AI model is deployed;

(The first entity is one of a Non-Access Stratum (NAS) entity, a Radio Resource Control (RRC) entity, a Service Data Adaptation Protocol (SDAP) entity, a Packet Data Convergence Protocol (PDCP) entity, a Radio Link Control (RLC) entity, a Medium Access Control (MAC) entity, a Physical layer (PHY) entity, or an AI protocol layer. The second entity is one of a NAS entity, an RRC entity, an SDAP entity, a PDCP entity, an RLC entity, a MAC entity, a PHY entity, or an AI protocol layer. Here, the first entity and the second entity are different from each other.

Here, the AI protocol layer is a newly defined protocol layer. Inter-layer interaction refers to the interaction between different protocol layers. Inter-layer interaction is an interactive behavior within the terminal.)
being transmitted from the first entity in the terminal to the second entity via a third AI interface;

(Illustratively, the third AI interface is a newly defined communication interface between different entities in the terminal. In the case where the input information comes from the first entity, the second entity receives the input information transmitted by the first entity via the third AI interface.)
being transmitted by a network device to the terminal via RRC signaling; or

(The RRC signaling is a signaling method for communication between a terminal and a network device. In the case where the input information comes from a network device, the terminal receives the input information transmitted by the network device via RRC signaling.)
being transmitted by the network device to the terminal via a fourth AI interface.

(Illustratively, the fourth AI interface is a newly defined communication interface between a terminal and a network device. In the case where the input information comes from the network device, the terminal receives the input information transmitted by the network device via the fourth AI interface.)

At Operation 404, the terminal trains or learns the input information based on a first AI model to obtain second information.

In this embodiment, the first AI model may be an AI model for training, learning or predicting the second information. The second information may be handover information, handover decision information, or auxiliary information for handover decision as used in a cell handover process.

Exemplarily, the first AI model is a neural network model, including: 1 input layer, 1 hidden layer, and 1 output layer. Alternatively, the first AI model may be a multi-hidden layer neural network model, including: 1 input layer, multiple cascaded hidden layers, and 1 output layer. Alternatively, the first AI model may be a convolutional neural network, including: 1 input layer, multiple cascaded convolutional units, 1 fully connected layer, and 1 output layer, each convolutional unit including a convolutional layer and a pooling layer. This embodiment is not limited to any specific structure of the first AI model.

For example, the second information may be information outputted from the first AI model after training or learning the input information. The second information may include at least one of:
identification information of a target cell;
beam information of the target cell;

(When the communication frequency is a high-frequency band, the target cell communicates with the terminal using a beam. The first AI model can predict the target beam of the target cell, and the terminal uses the target beam to communicate with the target cell.)
handover success probability of the target cell;

(When different neighboring cells are used as target cells for handover, the success probabilities may be different. The first AI model can predict the handover success probabilities when different neighboring cells are used as target cells, so as to assist the terminal in selecting the target cell with the highest success probability. Alternatively, when the success probability of the target cell with the highest success probability is still low, cell handover is not performed; or among multiple target cells with high success probabilities, a suitable target cell is determined based on other conditions.)
handover condition of the target cell;

(The handover condition includes: at least one of time, location, or channel quality.)
service prediction information of the terminal; or

(The service prediction information is information for predicting services that may run in the terminal in a future time period. For example, in the next 1 minute, the terminal will use a call service; or in the next 10 minutes, the terminal will use a game service.
trajectory prediction information of the terminal.

(The service prediction information is information for predicting a possible moving trajectory of the terminal in a future time period. For example, in the next 10 minutes, the terminal will move to a user's home; or in the next 20 minutes, the terminal will move to an airport.

At Operation 406, the terminal determines at least one handover information in the cell handover process based on second information.

When the second information includes the identification information of the target cell, the terminal determines the target cell in the cell handover process based on the identification information of the target cell.

When the second information includes the beam information of the target cell, the terminal determines the target beam used after handover to the target cell based on the beam information of the target cell.

When the second information includes the handover success probability of the target cell, the terminal decides whether to perform cell handover based on the handover success probability of the target cell, or selects an appropriate target cell based on the handover success probability of the target cell.

When the second information includes the handover condition of the target cell, the terminal performs the cell handover process if the handover condition of the target cell is satisfied.

When the second information includes the service prediction information of the terminal, the terminal selects an appropriate target cell according to the service predicted based on the service prediction information. For example, if the service prediction information indicates that the terminal will use a video service in the next minute, the terminal selects a cell that provides a video network slice as the target cell.

When the second information includes the trajectory prediction information of the terminal, the terminal selects an appropriate target cell based on the trajectory predicted based on the trajectory prediction information. For example, if the trajectory prediction information is that the terminal will move to an airport in the next minute, then the neighboring cell located in the direction of the airport is selected in advance as the target cell.

In some embodiments, before the operation 402, the method may further include: the terminal receiving configuration information of the first AI model transmitted by the network device. The terminal generates or constructs the first AI model according to the configuration information of the first AI model.

In some embodiments, the configuration information of the first AI model may include at least one of: a model type of the first AI model, a number of neural network layers, a type of each neural network layer, a cascading relationship between adjacent neural network layers, or a network parameter in each neural network layer.

Here, the configuration information of the first AI model may be obtained by training in advance at the network device. For example, the network device may train the first AI model in advance based on training samples obtained from a single UE, a plurality of UEs in a single area, and a plurality of UEs of a single type, and then obtains the configuration information of the first AI model.

In some embodiments, the method may further include: the terminal receiving an activation instruction transmitted by a network device, the activation instruction being used to activate the terminal to use the first AI model. After receiving the activation instruction, the terminal starts to use the first AI model.

Correspondingly, the method may further include: the terminal receiving a deactivation instruction transmitted by the network device, the deactivation instruction being used to deactivate the using of the first AI model by the terminal. After receiving the deactivation instruction, the terminal stops using the first AI model.

To summarize, in the method according to the embodiment of the present disclosure, the UE determines at least one handover information in the cell handover process based on autonomous decision-making of the AI model, and then selects an appropriate handover timing autonomously to complete cell handover, thereby improving the efficiency of the cell handover, reducing the time required for the cell handover, and ensuring the handover success rate.

Further, in the method according to this embodiment, the network device transmits the configuration information of the first AI model to the terminal, such that the terminal constructs the first AI model according to the configuration from the network device, without the need for the terminal itself to train the first AI model, which reduces the implementation complexity of the terminal itself.

Further, in the method according to this embodiment, the network device transmits an activation instruction or a deactivation instruction to the terminal, such that the UE uses the first AI model when needed (such as commuting to and from work) to improve the handover efficiency of the cell handover process and stops using the first AI model when it is not needed (such as during sleep at night) to reduce the power consumption of the terminal.

It should be noted that the first AI model at the terminal and the AI model at the network may be synchronous or asynchronous. The term “synchronization” here includes: whether the input information is same, and whether model parameters are same.

In an illustrative example, the terminal receives a handover command transmitted by a network device. The handover command includes the configuration of the target cell and the handover type supported by the target cell, such as conditional handover, DAPS handover, traditional handover, RACH-LESS handover, etc.

Furthermore, the configurations corresponding to different handover types may be same or different. For example, the configuration of conditional handover includes a configuration of the target cell and a handover condition of the target cell, and the configuration of RACH-LESS handover includes Time Advance (TA).

The terminal determines the handover type in the cell handover process based on the second information given by the first AI model. For example, the second information includes service prediction information, which indicates that the terminal will have a service arriving during the cell handover process. Then the terminal selects DAPS handover (Oms handover) to ensure service continuity during the cell handover process.

Further, the handover command may further include a plurality of target cells, and the terminal may further determine the target cell based on the second information. Illustratively, the second information may include identification information of the target cell, which directly indicates that the target cell x is the cell which the terminal is to be handed over to.

For example, if the first AI model predicts that the UE will have a large amount of services in a subsequent period of time, the first AI model will select a neighboring cell with a low cell load as the target cell. In another example, if the first AI model predicts that the terminal has not yet reached the edge of the serving cell, then the first AI model will choose to let the UE perform conditional handover of the target cell, that is, wait until the terminal reaches the edge of the target cell before performing handover, so as to avoid premature handover.

In an illustrative example, for the conditional handover, the first AI model can also provide auxiliary information. The auxiliary information is used to assist the UE in triggering the conditional handover. For example, the network device configures the conditional handover configuration to the terminal. The conditional handover configuration includes a plurality of target cells and handover conditions, and the first AI model can assist the terminal in selecting a target cell:

For example, the first AI model can select a cell where the terminal will reside at the next time point based on the trajectory prediction information of the terminal.

For example, the first AI model can select a cell with the highest handover success probability for the terminal based on the load of the target cell.

For example, the first AI model may select a cell for the terminal that can guarantee the QoS of subsequent services based on service prediction information for the terminal.

The auxiliary information may specifically be an identifier of the target cell, or a handover success rate of the target cell, or weight information of the target cell, etc. The terminal selects the target cell based on the auxiliary information and performs handover.

FIG. 7 shows a block diagram of a cell handover apparatus according to an exemplary embodiment of the present disclosure. The apparatus can be applied in a terminal or implemented as a part of a terminal. The apparatus includes:

a determining module 720 configured to determine at least one handover information in a cell handover process based on a first AI model.

In an embodiment, the apparatus may further include:
a receiving module 740 configured to receive first information transmitted by a network device, the first information being information obtained by the first AI model deployed in the network device that is trained or learned from input information; and
the determining module 720 may be configured to determine at least one handover information based on the first information.

In an embodiment, the first information may include at least one of:
a handover command;
a measurement configuration;
a configuration of a target cell; or
a handover condition of the target cell.

In an embodiment, the input information may include at least one of:
location information of a terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

In an embodiment, the input information may be obtained by at least one of following ways:
being transmitted by a neighboring cell network device to the network device via an Xn interface;
being transmitted by the neighboring cell network device to the network device via a first AI interface;
being transmitted by the terminal to the network device via Radio Resource Control (RRC) signaling; or
being transmitted by the terminal to the network device via a second AI interface.

In an embodiment, the determining module 720 may be configured to determine the at least one handover information based on second information, the second information being information obtained by the first AI model deployed in a terminal that is predicted from input information.

In an embodiment, the second information may include at least one of:
identification information of a target cell;
beam information of the target cell;
a handover success probability of the target cell;
a handover condition of the target cell;
service prediction information of the terminal; or
trajectory prediction information of the terminal.

In an embodiment, the input information may include at least one of:
location information of the terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

In an embodiment, the input information may be obtained by at least one of following ways:
being transmitted from a first entity in the terminal to a second entity via inter-layer interaction, the second entity being an entity in which the first AI model is deployed;
being transmitted from the first entity in the terminal to the second entity via a third AI interface;
being transmitted by a network device to the terminal via RRC signaling (i.e., the receiving module 740 may be configured to receive the RRC signaling transmitted by the network device, and the RRC signaling carries the input information); or
being transmitted by the network device to the terminal via a fourth AI interface (i.e., the receiving module 740 may be configured to receive the input information transmitted by the network device via the fourth AI interface).

In an embodiment, the second entity may be at least one of a NAS entity, an RRC entity, an SDAP entity, a PDCP entity, an RLC entity, a MAC entity, a PHY entity, or an AI protocol layer.

In an embodiment, the receiving module 740 may be further configured to receive configuration information of the first AI model transmitted by a network device.

In an embodiment, the receiving module 740 may be further configured to receive an activation instruction transmitted by a network device, the activation instruction being used to activate the terminal to use the first AI model.

In an embodiment, the receiving module 740 may be further configured to receive a deactivation instruction transmitted by a network device, the deactivation instruction being used to instruct the terminal to stop using the first AI model or deactivating the using of the first AI model by the terminal.

FIG. 8 shows a block diagram of a cell handover apparatus according to an exemplary embodiment of the present disclosure. The apparatus can be applied in a network device, or implemented as a part of a network device. The apparatus includes:
an AI module 820 configured to train or learn input information based on a first AI model to obtain first information; and
a transmitting module 840 configured to transmit the first information to a terminal, the terminal being configured to determine at least one handover information in a cell handover process based on the first information.

In an embodiment, the first information may include at least one of:
a handover command;
a measurement configuration;
a configuration of a target cell; or
a handover condition of the target cell.

In an embodiment, the input information may include at least one of:
location information of the terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

In an embodiment, the apparatus may further include: a receiving module 860 configured to perform at least one of:
receiving the input information transmitted by a neighboring cell network device via an Xn interface;
receiving the input information transmitted by the neighboring cell network device via a first AI interface;
receiving the input information transmitted by the terminal via RRC signaling; or
receiving the input information transmitted by the terminal via a second AI interface.

In an embodiment, the transmitting module 840 may be further configured to transmit configuration information of the first AI model to the terminal.

In an embodiment, the transmitting module 840 may be further configured to transmit an activation instruction to the terminal, the activation indication being used to activate the terminal to use the first AI model.

It should be noted that when the apparatus according to the above embodiment implements its functions, the division of the above functional modules is used as an example for illustration only. In practical applications, the above functions can be allocated to different functional modules according to actual needs. That is, the content or structure of the apparatus can be divided into different functional modules to complete all or part of the functions described above.

Regarding the apparatus in the above embodiment, the specific implementation for each module to perform operations has been described in detail in the embodiments related to the method, and details thereof will be omitted here.

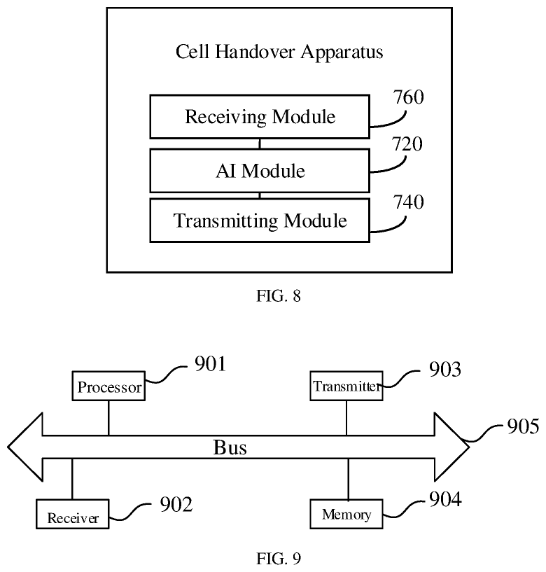

FIG. 9 is a schematic diagram showing a structure of a terminal or network device according to an exemplary embodiment of the present disclosure. The terminal or network device includes: a processor 901, a receiver 902, a transmitter 903, a memory 904, and a bus 905.

The processor 901 includes one or more processing cores, and the processor 901 executes various functional applications and information processing by executing software programs and modules.

The receiver 902 and the transmitter 903 can be implemented as a communication component, and the communication component can be a communication chip.

The memory 904 is connected to the processor 901 via the bus 905.

The memory 904 may store at least one instruction, and the processor 901 may be configured to execute the at least one instruction, so as to implement the operations in any of the above method embodiments.

In addition, the memory 904 can be implemented as any type of volatile or non-volatile storage device or any combination thereof. The volatile or non-volatile storage device includes but not limited to: magnetic disk or optical disc, Electrically Erasable Programmable Read Only Memory (EEPROM), Erasable Programmable Read Only Memory (EPROM), Static Random-Access Memory (SRAM), Read Only Memory (ROM), magnetic memory, flash memory, or Programmable Read Only Memory (PROM).

In an exemplary embodiment, a computer-readable storage medium is also provided. The computer-readable storage medium has at least one instruction stored therein. For example, a memory may include instructions that can be executed by a processor to implement the above method embodiments. For example, the computer-readable storage medium can be ROM, Random-Access Memory (RAM), Compact Disc Read Only Memory (CD-ROM), magnetic tape, floppy disk, and optical data storage device, etc. In some embodiments, the computer-readable storage medium may be a non-transitory computer-readable storage medium.

In an exemplary embodiment, an embodiment of the present disclosure provides a computer program product or computer program. The computer program product or computer program includes one or more instructions, and the one or more instructions are stored in a computer-readable storage medium. One or more processors of the terminal device read the one or more instructions from the computer-readable storage medium, and execute the one or more instructions, such that the terminal or network device implements the above method embodiments.

It should be understood that the term “plurality” as used herein means two or more. The term “and/or” as used herein only represents a relationship between correlated objects, including three relationships. For example, “A and/or B” may mean A only, B only, or both A and B. In addition, the symbol “/” as used herein represents an “or” relationship between the correlated objects preceding and succeeding the symbol.

Other embodiments of the present disclosure may be readily envisaged by those skilled in the art after considering the description and practicing the present disclosure. The present disclosure is intended to cover any variants, uses, or adaptations of the present disclosure without departing from the general principles of the present disclosure and the common knowledge or conventional techniques in the related art. The description and embodiments are to be regarded as exemplary only, and the scope and spirit of the present disclosure are defined by the claims as attached.

It can be appreciated that the present disclosure is not limited to the exact structures described above and illustrated in the accompanying drawings, and that various modifications and changes may be made without departing from the scope of the present disclosure, which is defined only by the claims as attached.

What is claimed is:

1. A cell handover method, comprising:
determining at least one handover information in a cell handover process based on a first Artificial Intelligence (AI) model.

2. The method according to claim 1, wherein said determining the at least one handover information based on the first AI model comprises:
receiving first information transmitted by a network device, the first information being information obtained by the first AI model deployed in the network device that is trained or learned from input information; and
determining the at least one handover information based on the first information.

3. The method according to claim 2, wherein the first information comprises at least one of:
a handover command;
a measurement configuration;
a configuration of a target cell; or
a handover condition of the target cell.

4. The method according to claim 2, wherein the input information comprises at least one of:
location information of a terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

5. The method according to claim 2, wherein the input information is obtained by at least one of following ways:
being transmitted by a neighboring cell network device to the network device via an Xn interface;
being transmitted by the neighboring cell network device to the network device via a first AI interface;
being transmitted by a terminal to the network device via Radio Resource Control (RRC) signaling; or
being transmitted by the terminal to the network device via a second AI interface.

6. The method according to claim 1, wherein said determining the at least one handover information based on the first AI model comprises:
determining the at least one handover information based on second information, the second information being information obtained by the first AI model deployed in a terminal that is predicted from input information.

7. The method according to claim 6, wherein the second information comprises at least one of:
identification information of a target cell;
beam information of the target cell;
a handover success probability of the target cell;
a handover condition of the target cell;
service prediction information of the terminal; or
trajectory prediction information of the terminal.

8. The method according to claim 6, wherein the input information comprises at least one of:
location information of the terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

9. The method according to claim 6, wherein the input information is obtained by at least one of following ways:
being transmitted from a first entity in the terminal to a second entity via inter-layer interaction, the second entity being an entity in which the first AI model is deployed;
being transmitted from the first entity in the terminal to the second entity via a third AI interface;
being transmitted by a network device to the terminal via RRC signaling; or
being transmitted by the network device to the terminal via a fourth AI interface.

10. The method according to claim 9, wherein the second entity is one of a Non-Access Stratum (NAS) entity, a Radio Resource Control (RRC) entity, a Service Data Adaptation Protocol (SDAP) entity, a Packet Data Convergence Protocol (PDCP) entity, a Radio Link Control (RLC) entity, a Medium Access Control (MAC) entity, a Physical layer (PHY) entity, or an AI protocol layer.

11. The method according to claim 6, further comprising:
receiving configuration information of the first AI model transmitted by a network device.

12. The method according to claim 6, further comprising:
receiving an activation instruction transmitted by a network device, the activation instruction being used to activate the terminal to use the first AI model.

13. A cell handover method, comprising:
training or learning input information based on a first AI model to obtain first information; and
transmitting the first information to a terminal, the terminal being configured to determine at least one handover information in a cell handover process based on the first information.

14. The method according to claim 13, wherein the first information comprises at least one of:
a handover command;
a measurement configuration;
a configuration of a target cell; or
a handover condition of the target cell.

15. The method according to claim 13, the input information comprises at least one of:
location information of the terminal;
uplink service information and downlink service information of the terminal;
a measurement report of the terminal;
handover failure information of the terminal in a historical period;
deployment information of a mobile network;
cell load information; or
auxiliary information provided by a third-party application in the terminal.

16. The method according to claim 13, further comprising at least one of:
receiving the input information transmitted by a neighboring cell network device via an Xn interface;
receiving the input information transmitted by the neighboring cell network device via a first AI interface;
receiving the input information transmitted by the terminal via RRC signaling; or
receiving the input information transmitted by the terminal via a second AI interface.

17. A terminal, comprising:
one or more processors; and
one or more transceivers connected to the one or more processors,
wherein the one or more processors are configured to load and execute executable instructions, so as to perform:
determining at least one handover information in a cell handover process based on a first Artificial Intelligence (AI) model.

18. The terminal according to claim 17, wherein said determining the at least one handover information based on the first AI model comprises:
receiving first information transmitted by a network device, the first information being information obtained by the first AI model deployed in the network device that is trained or learned from input information; and
determining the at least one handover information based on the first information.

19. The terminal according to claim 18, wherein the first information comprises at least one of:
a handover command;
a measurement configuration;
a configuration of a target cell; or
a handover condition of the target cell.

20. A network device, comprising:
one or more processors; and
one or more transceivers connected to the one or more processors,
wherein the one or more processors are configured to load and execute executable instructions, so as to perform the cell handover method according to claim 13.
